(19) United States
(12) Patent Application Publication
(10) Pub. No.: US 2024/0395465 A1
(43) Pub. Date: Nov. 28, 2024

(54) MULTILAYER CERAMIC CAPACITOR

(71) Applicant: Murata Manufacturing Co., Ltd., Nagaokakyo-shi (JP)

(72) Inventors: Kazuhiro NISHIBAYASHI, Nagaokakyo-shi (JP); Yuko KAWASAKI, Nagaokakyo-shi (JP); Satoshi ISHITOBI, Nagaokakyo-shi (JP)

(21) Appl. No.: 18/792,625

(22) Filed: Aug. 2, 2024

Related U.S. Application Data
(63) Continuation of application No. PCT/JP2023/015059, filed on Apr. 13, 2023.

(30) Foreign Application Priority Data
Jun. 2, 2022 (JP) 2022-090134

(51) Int. Cl. H01G 4/30; H01G 4/012; H01G 4/12; H01G 4/232

(52) U.S. Cl. CPC H01G 4/30; H01G 4/012; H01G 4/12; H01G 4/232

(57) ABSTRACT

A multilayer ceramic capacitor includes a multilayer body including internal electrode layers and dielectric layers alternately laminated, and external electrodes on at least a pair of opposite outer surfaces of the multilayer body and extending in a lamination direction. Each internal electrode layer includes a counter portion and a lead-out portion extending from the counter portion to the external electrode, and the counter portion of one of a pair of the internal electrode layers adjacent to each other in the lamination direction overlaps with the counter portion of each of a remainder of the internal electrode layers. The counter portion includes on edges thereof a convex-concave portion including a convexity and a concavity alternating with each other, the convexity bending toward the outer surface adjacent to the edge, the concavity bending away from the outer surface adjacent to the edge.

### CROSS REFERENCE TO RELATED APPLICATIONS

This application claims the benefit of priority to Japanese Patent Application No. 2022-090134 filed on Jun. 2, 2022 and is a Continuation Application of PCT Application No. PCT/JP2023/015059 filed on Apr. 13, 2023. The entire contents of each application are hereby incorporated herein by reference.

### BACKGROUND OF THE INVENTION

### 1. Field of the Invention

The present invention relates to multilayer ceramic capacitors.

### 2. Description of the Related Art

In recent years, the trend toward lower impedance in electronic circuit lines, particularly in mobile device products, has accelerated, and there is an increasing demand for multilayer ceramic capacitors that have a larger capacitance and are for use for decoupling applications, for example. For the purpose of increasing the capacitance of a multilayer ceramic capacitor, for example, an approach of reducing the thickness of dielectric layers and an approach of increasing the areas of internal electrode layers have been taken (for example, see Japanese Unexamined Patent Application, Publication No. 2003-234241).

### SUMMARY OF THE INVENTION

However, the aforementioned approaches increase the possibility of an electrical short circuit or the like due to a defect of an internal electrode, for example.

Example embodiments of the present invention provide multilayer ceramic capacitors each capable of achieving an increase in capacitance without increasing the possibility of an electrical short circuit.

An example embodiment of the present invention is directed to a multilayer ceramic capacitor including a multilayer body including internal electrode layers and dielectric layers that are alternately laminated, and external electrodes on at least a pair of opposite outer surfaces from among outer surfaces of the multilayer body and extending in a lamination direction. Each of the internal electrode layers includes a counter portion and a lead-out portion that extends from the counter portion to the external electrode, and the counter portion of one of the internal electrode layers adjacent to each other in the lamination direction overlaps with the counter portion of each of a remainder of the internal electrode layers. The counter portion includes on edges thereof, a convex-concave portion that includes a convexity and a concavity alternating with each other, the convexity bending toward the outer surface adjacent to the edge, the concavity bending away from the outer surface adjacent to the edge.

Each of the multilayer ceramic capacitors according to example embodiments of the present invention is capable of achieving an increase in capacitance without increasing the possibility of an electrical short circuit.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a schematic perspective view of a multilayer ceramic capacitor 1.

FIG. 2 is a cross-sectional view of the multilayer ceramic capacitor 1, taken along line II-II in FIG. 1.

FIG. 3 is a cross-sectional view of the multilayer ceramic capacitor 1, taken along the line III-III in FIG. 1.

FIG. 4 is a cross-sectional view of the multilayer ceramic capacitor 1, taken along an end-surface-connection internal electrode layer 15A.

FIG. 5 is a cross-sectional view of the multilayer ceramic capacitor 1, taken along a side-surface-connection internal electrode layer 15B.

FIG. 6 is a perspective view of internal electrode layers 15 as viewed from one of main surfaces A provided on both sides in a lamination direction T.

FIG. 7 is a cross-sectional view taken along line IV-IV in FIG. 6.

FIG. 8 is a flowchart illustrating a method of manufacturing the multilayer ceramic capacitor 1.

FIG. 9 is a diagram illustrating an internal electrode pattern forming step S1 and a laminating step S2 included in the method of manufacturing the multilayer ceramic capacitor 1.

FIG. 10 is a diagram illustrating electric lines of force that are generated between internal electrode layers in a case where two internal electrode layers are provided.

FIG. 11 is a table showing results of measurement of the capacitances of the multilayer ceramic capacitors of Examples and a Comparative Example.

FIG. 12 is a table showing the results of measurement of the capacitance of the multilayer ceramic capacitors of Examples and a Comparative Example.

FIG. 13 is a table showing the results of measurement of the capacitance of the multilayer ceramic capacitors of Examples and a Comparative Example.

FIG. 14 is an exploded perspective view of a multilayer body 2 in a multilayer ceramic capacitor according to a modification of an example embodiment of the present invention.

### DETAILED DESCRIPTION OF THE EXAMPLE EMBODIMENTS

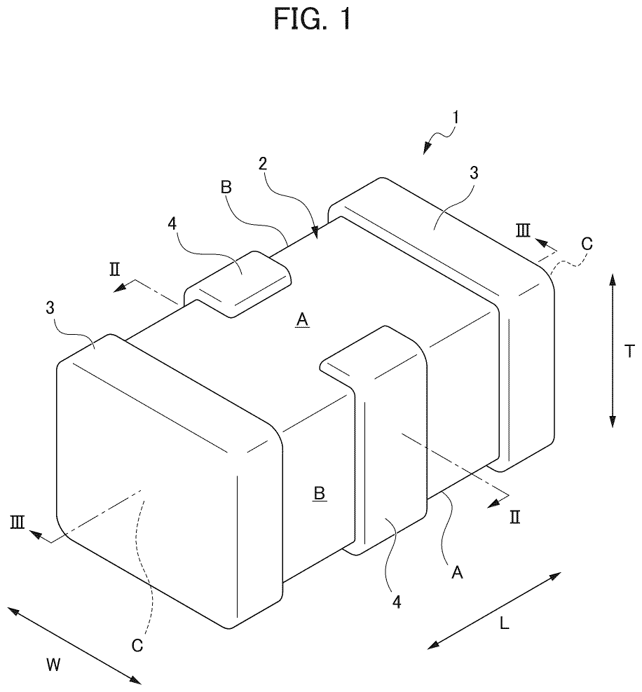

Multilayer ceramic capacitors according to example embodiments of the present invention will be described below. FIG. 1 is a schematic perspective view of a multilayer ceramic capacitor 1 according to an example embodiment of the present invention.

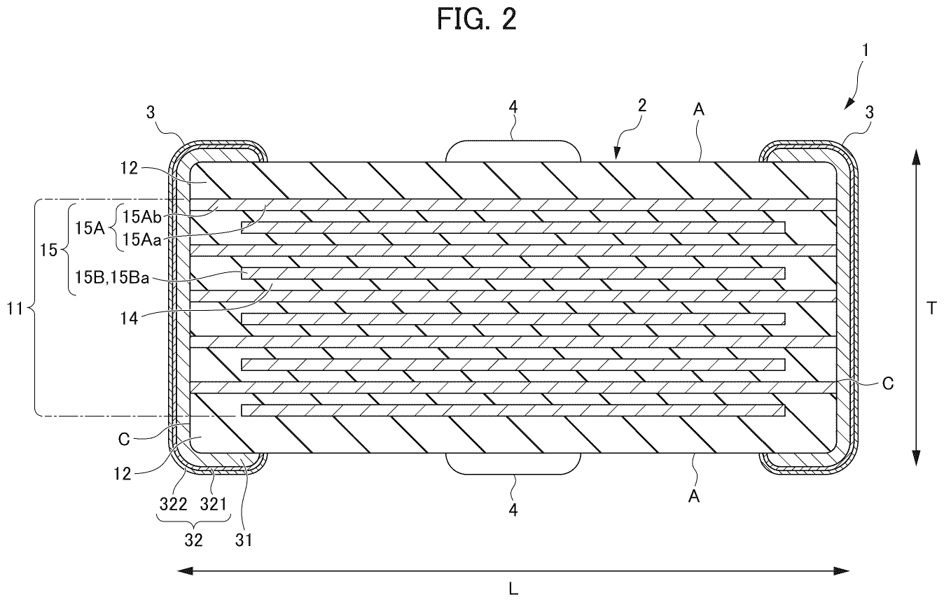

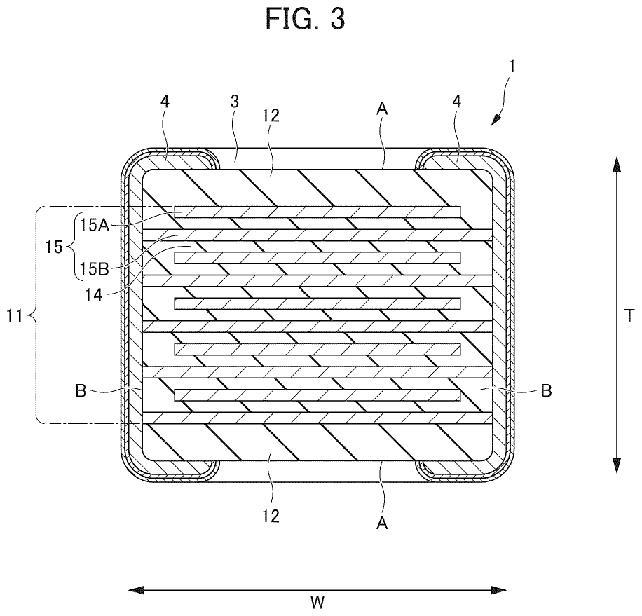

FIG. 2 is a cross-sectional view of the multilayer ceramic capacitor 1, taken along the line II-II in FIG. 1. FIG. 3 is a cross-sectional view of the multilayer ceramic capacitor 1, taken along the line III-III in FIG. 1.

### Multilayer Ceramic Capacitor 1

The multilayer ceramic capacitor 1 includes a multilayer body 2, end-surface external electrodes 3 provided on both end surfaces C of the multilayer body 2 in a length direction L, and side-surface external electrodes 4 provided on both side surfaces B of the multilayer body 2 in a width direction W. The multilayer body 2 includes an inner layer portion 11 in which dielectric layers 14 and internal electrode layers 15 are laminated, and outer layer portions 12.

In the present specification, as a term expressing the orientation of the multilayer ceramic capacitor 1, a direction in which the dielectric layers 14 and the internal electrode layers 15 are laminated in the multilayer ceramic capacitor 1 is referred to as a lamination direction T. A direction which intersects with the lamination direction T and in which the pair of end-surface external electrodes 3 are arranged is defined as the length direction L. A direction that intersects both the length direction L and the lamination direction T is defined as the width direction W. In the present example embodiment, the lamination direction T, the length direction L, and the width direction W are orthogonal to one another.

Furthermore, in the following description, among the six outer surfaces of the multilayer body 2, a pair of outer surfaces situated on both sides in the lamination direction T are referred to as main surfaces A, a pair of outer surfaces extending in the lamination direction T and situated on both sides in the width direction W are referred to as side surfaces B, and a pair of outer surfaces extending in the lamination direction T and situated on both sides in the length direction L are referred to as end surfaces C.

### Multilayer Body 2

The multilayer body 2 includes the inner layer portion 11 and the outer layer portions 12 that are disposed on both sides of the inner layer portion 11 in the lamination direction T. The multilayer body 2 preferably has rounded corners and rounded ridges. Each corner is where three surfaces of the multilayer body 2 meet one another, and each ridge is where two surfaces of the multilayer body 2 meet each other.

### Inner Layer Portion 11

In the inner layer portion 11, the plurality of dielectric layers 14 and the plurality of internal electrode layers 15 are laminated in the lamination direction T.

### Dielectric Layer 14

Each dielectric layer 14 is made of a ceramic material.

For example, a dielectric ceramic material including BaTiO₃ as one of main components may be used as the ceramic material. Alternatively, it is possible to use a ceramic material including, in addition to the main components, at least one selected from subcomponents including a Mn compound, a Fe compound, a Cr compound, a Co compound, a Ni compound, etc.

### Internal Electrode Layer 15

Each internal electrode layer 15 is preferably made of a metal material representative examples of which include Ni, Cu, Ag, Pd, an Ag—Pd alloy, Au, etc.

The internal electrode layers 15 include a plurality of end-surface-connection internal electrode layers 15A and a plurality of side-surface-connection internal electrode layers 15B, which are alternately arranged. The end-surface-connection internal electrode layer 15A and the side-surface-connection internal electrode layer 15B are collectively referred to as the internal electrode layer 15 when it is unnecessary to particularly distinguish from each other.

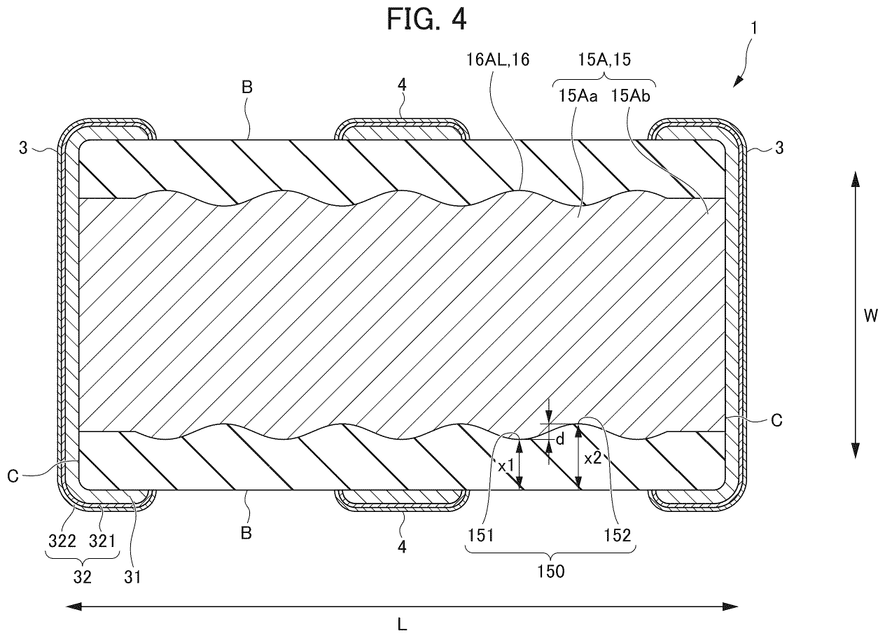

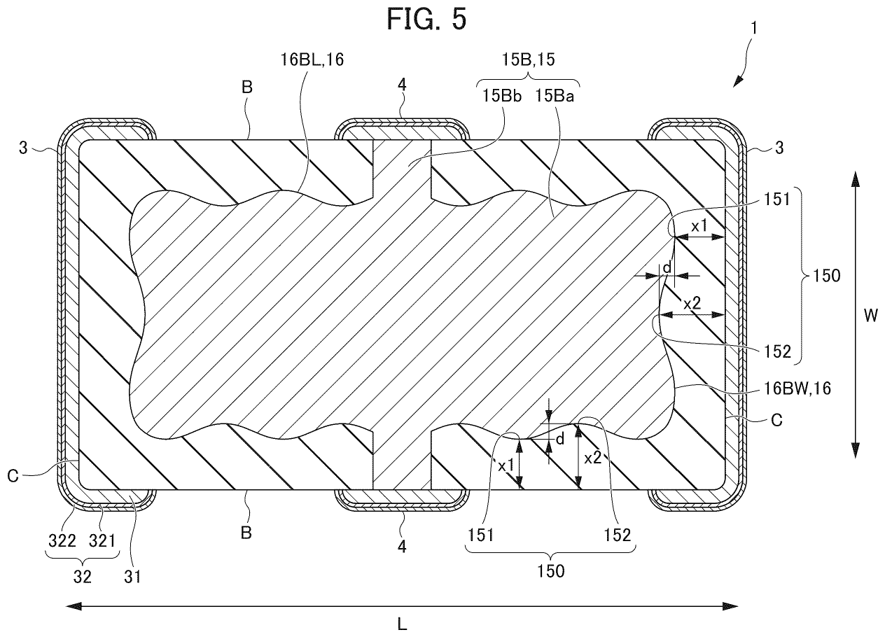

FIG. 4 is a cross-sectional view of the multilayer ceramic capacitor 1, taken along the end-surface-connection internal electrode layer 15A. FIG. 5 is a cross-sectional view of the multilayer ceramic capacitor 1, taken along the side-surface-connection internal electrode layer 15B.

### End-Surface-Connection Internal Electrode Layer 15A

As illustrated in FIG. 4, each end-surface-connection internal electrode layer 15A extends between both end surfaces C of the multilayer body 2 in the length direction L and is spaced apart from both side surfaces B in the width direction W by a certain distance. Each end-surface-connection internal electrode layer 15A has an end-surface-connection counter portion 15Aa separated from both end surfaces C by a certain distance, and end-surface-connection lead-out portions 15Ab extending from the end-surface-connection counter portion 15Aa to both end surfaces C, respectively. The end-surface-connection lead-out portions 15Ab extend to both end surfaces C of the multilayer body 2 to be exposed at the end surfaces C, respectively, and are connected to the end-surface external electrodes 3 provided on both end surfaces of the multilayer body 2 in the length direction L.

### Side-Surface-Connection Internal Electrode Layer 15B

As illustrated in FIG. 5, each side-surface-connection internal electrode layer 15B is slightly smaller than a cross section of the multilayer body 2, has a side-surface-connection counter portion 15Ba whose sides are spaced apart from the end surfaces C and the side surfaces B by certain distances, and has side-surface-connection lead-out portions 15Bb extending from the side-surface-connection counter portion 15Ba to both side surfaces B, respectively. The side-surface-connection lead-out portions 15Bb extend to both side surfaces B of the multilayer body 2 to be exposed at the side surfaces B, respectively, and are connected to the side-surface external electrodes 4 provided on both side surfaces of the multilayer body 2 in the width direction W.

The end-surface-connection counter portions 15Aa and the side-surface-connection counter portions 15Ba are arranged opposite to each other to define a capacitor portion.

In the following description, the end-surface-connection counter portion 15Aa and the side-surface-connection counter 15Ba will be collectively referred to as the counter portion portions 15a when it is unnecessary to particularly distinguish from each other. The end-surface-connection lead-out portion 15Ab and the side-surface-connection lead-out portion 15Bb will be collectively referred to as the lead-out portions 15b when it is unnecessary to particularly distinguish from each other.

As illustrated in FIGS. 4 and 5, each counter portion 15a of the present example embodiment has, on its edges 16, convex-concave portions 150 each including convexities 151 and concavities 152 that alternate with each other. The convexities 151 bend toward an outer surface adjacent to the edge 16, and the concavities 152 bend away from the outer surface.

Specifically, the end-surface-connection counter portion 15Aa of the end-surface-connection internal electrode layer 15A illustrated in FIG. 4 includes, on each edge 16AL extending in the length direction L, a convex-concave portion 150 including convexities 151 that bend toward the side surface B adjacent to the edge 16AL and concavities 152 that bend away from the side surface B and alternate with the convexities 151.

More specifically, each edge 16AL is provided with, between the two end surfaces C, five convexities 151 and four concavities 152 each located between the adjacent convexities 151, for example.

The convex-concave portion 150 on each edge 16AL preferably includes two or more consecutive sets of one convexity 151 and one concavity 152, and in the present example embodiment, includes four consecutive sets, for example.

The side-surface-connection counter portion 15Ba of the side-surface-connection internal electrode layer 15B illustrated in FIG. 5 includes, on each edge 16BL extending in the length direction L, a convex-concave portion 150 including convexities 151 that bend toward the side surface B adjacent to the edge 16BL and concavities 152 that bend away from the side surface B and alternate with the convexities 151.

More specifically, each edge 16BL is provided with, on each of its portions sandwiching the side-surface-connection lead-out portion 15Bb therebetween, a concavity 152, a convexity 151, a concavity 152, and a convexity 151 that are arranged in this order from the side-surface-connection lead-out portion 15Bb toward the end surface C.

The convex-concave portion 150 on each edge 16BL preferably includes two or more consecutive sets of one convexity 151 and one concavity 152, and in the present example embodiment, includes two consecutive sets, for example.

The side-surface-connection counter portion 15Ba of the side-surface-connection internal electrode layer 15B includes, also on each edge 16BW extending in the width direction W, a convex-concave portion 150 including convexities 151 that bend toward the end surface C adjacent to the edge 16BW and a concavity 152 that bends away from the end surface C and alternate with the convexities 151.

More specifically, each edge 16BW is provided with two convexities 151 and one concavity 152 therebetween, for example.

The convex-concave portion 150 includes a location at which a concave-convex difference d, which is a difference between a distance x1 from an outermost point of the convexity 151 to an outer surface and a distance x2 from an innermost point of the concavity 152 adjacent to the convexity 151 to the outer surface, is about 3 μm or more, for example.

Specifically, the convex-concave portion 150 provided on at least one edge 16 of the edges 16BL, the edges 16BW, and the edges 16AL includes a location at which the concave-convex difference d is about 3 μm or more, for example.

It is preferable that each of the convex-concave portions 150 on all the edges 16, i.e., all of the edges 16BL, the edges 16BW, and the edges 16AL includes a location at which the concave-convex difference d is about 3 μm or more, for example.

Furthermore, it is more preferable that on all the edges 16, i.e., on all of the edges 16BL, the edges 16BW, and the edges 16AL, each convexity 151 and the adjacent concavity 152 have a convex-concave difference d of about 3 μm or more, for example.

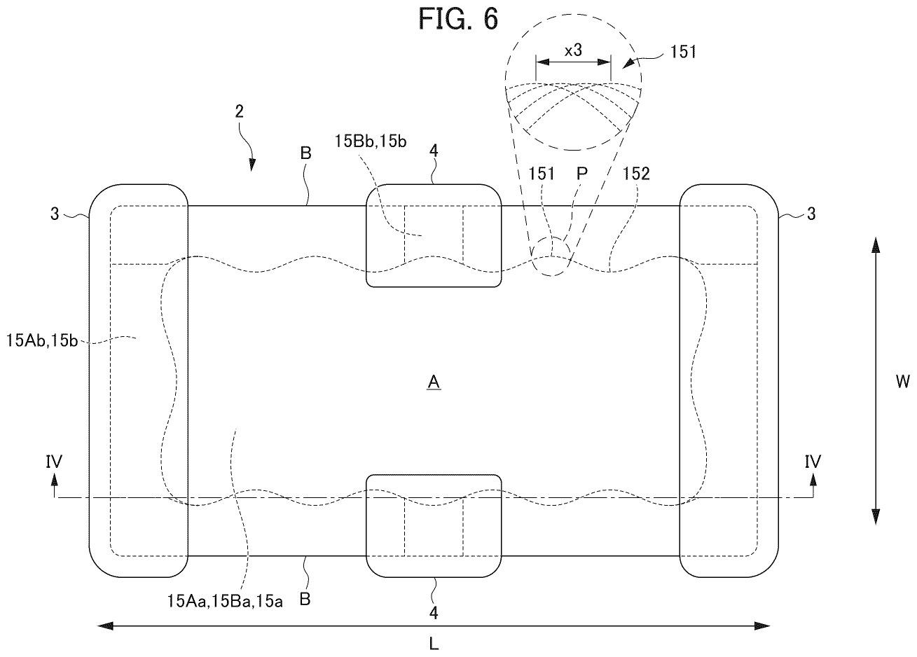

FIG. 6 is a perspective view of the internal electrode layers 15 as viewed from one of the main surfaces A. An arrow indicates an enlarged view of the portion P surrounded by a broken line in FIG. 6. In the present example embodiment, it is preferable that a positional deviation x3 between the outermost points of the convexities 151 of the plurality of internal electrode layers 15 disposed in the multilayer body 2 is about 250 μm or less in the length direction L, for example.

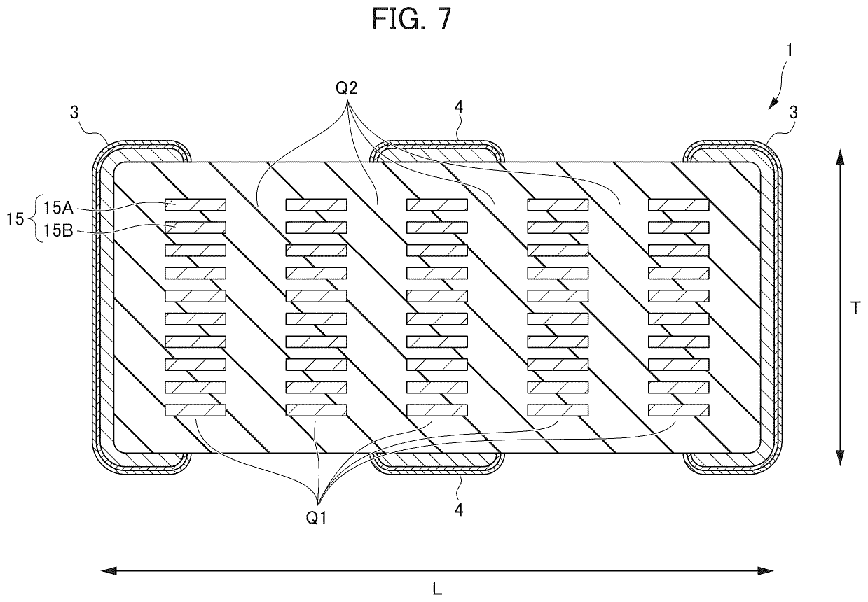

FIG. 7 is a cross-sectional view taken along the line IV-IV in FIG. 6. Specifically, FIG. 7 illustrates a cross section that extends in the length direction L and the lamination direction T and is spaced farther apart than the outermost points of the convexities 151 and less apart than the innermost points of the concavities 152 from the side surface B. In this cross-sectional view, regions Q1 where the internal electrode layers 15 are exposed and are arranged one above the other in the lamination direction T alternate with regions Q2 where the internal electrode layers 15 are not exposed and are arranged one above the other in the lamination direction T.

### Outer Layer Portion 12

Referring back to FIGS. 2 and 3, the outer layer portions 12 each include a dielectric layer having a predetermined thickness and are disposed on the sides of the inner layer portion 11 that are adjacent to the main surfaces A. The outer layer portions 12 are made of the same material as that of the dielectric layers 14 included in the inner layer portion 11.

### End-Surface External Electrode 3

The end-surface external electrodes 3 are disposed on both end surfaces C of the multilayer body 2. The end-surface external electrodes 3 are connected to the end-surface-connection lead-out portions 15Ab of the end-surface-connection internal electrode layers 15A. Each end-surface external electrode 3 covers not only the end surface C but also a portion of each main surface A adjacent to the end surface C and a portion of each side surface B adjacent to the end surface C.

### Side-Surface External Electrode 4

The side-surface external electrodes 4 are disposed on both side surfaces B of the multilayer body 2. The side-surface external electrodes 4 are connected to the side-surface-connection lead-out portions 15Bb of the side-surface-connection internal electrode layers 15B. Each side-surface external electrode 4 covers not only a portion of the side surface B but also a portion of each main surface A adjacent to the side surface B.

The end-surface external electrodes 3 and the side-surface external electrodes 4 each include a base electrode layer 31 and a plated layer 32 disposed on the base electrode layer 31. The plated layer 32 includes a nickel (Ni) plated layer 321 disposed on the base electrode layer 31 and a tin (Sn) plated layer 322 disposed on the Ni plated layer 321.

### Method of Manufacturing Multilayer Ceramic Capacitor 1

Next, a method of manufacturing the multilayer ceramic capacitor 1 according to the present example embodiment will be described.

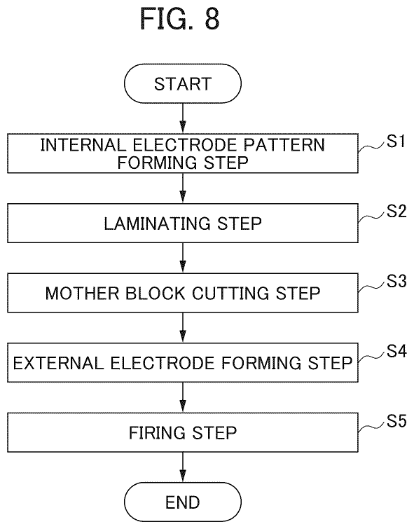

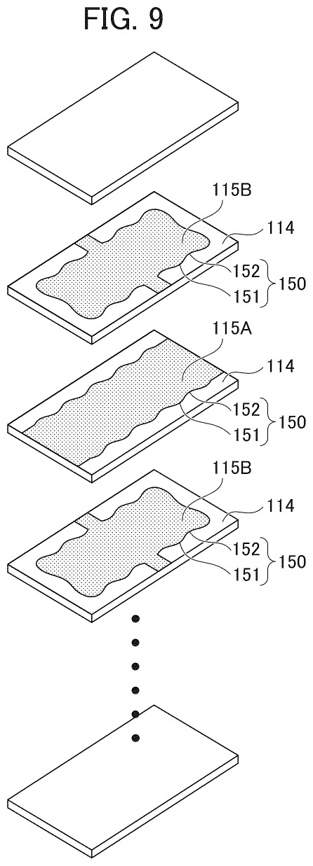

FIG. 8 is a flowchart illustrating a method of manufacturing the multilayer ceramic capacitor 1. FIG. 9 is a diagram illustrating an internal electrode pattern forming step S1 and a laminating step S2 included in the method of manufacturing the multilayer ceramic capacitor 1.

### Internal Electrode Pattern Forming Step S1

First, a conductive paste is printed into a side-surface-connection internal electrode layer pattern 115B, which is to form the side-surface-connection internal electrode layer 15B, on a ceramic green sheet 114 for forming the dielectric layer 14. Furthermore, a conductive paste is printed into an end-surface-connection internal electrode layer pattern 115A, which is to form the end-surface-connection internal electrode layer 15A, on a first ceramic green sheet 114A for forming the dielectric layer 14.

The ceramic green sheet 114 is a strip-shaped sheet prepared by forming a ceramic slurry that contains ceramic powder, a binder, and a solvent into a sheet shape on a carrier film, using a die coater, a gravure coater, a micro gravure coater, or the like.

The end-surface-connection internal electrode layer pattern 115A and the side-surface-connection internal electrode layer pattern 115B are formed by way of printing, such as screen printing, gravure printing, or letterpress, for example. This printing process includes forming the convexities 151 and the concavities 152 on edges of the end-surface-connection internal electrode layer pattern 115A and edges of the side-surface-connection internal electrode layer pattern 115B.

The convexities and concavities are formed in the following way, for example. The end-surface-connection internal electrode layer pattern 115A and the side-surface-connection internal electrode layer pattern 115B each including the convexities 151 and the concavities 152 may be printed on the ceramic green sheets 114. Alternatively, the end-surface-connection internal electrode layer pattern 115A and the side-surface-connection internal electrode layer pattern 115B without the convexity 151 or the concavity 152 on the edges 16, that is, the patterns 115A and 115B having straight edges may be printed first, and thereafter, the convexities 151 and the concavities 152 may be printed and added.

### Laminating Step S2

The sheets each having thereon the end-surface-connection internal electrode layer pattern 115A and the sheets each having thereon the side-surface-connection internal electrode layer pattern 115B are alternately laminated. Subsequently, the plurality of laminated sheets and ceramic green sheets 112 for forming the outer layer portions 12 are thermocompression-bonded, thereby forming a mother block.

### Mother Block Cutting Step S3

Next, the mother block is cut and divided along the length direction L and the width direction W, thereby producing a plurality of rectangular multilayer bodies 2.

### External Electrode Forming Step S4

Next, the end-surface external electrodes 3 are formed on both end surfaces C of the multilayer body 2, and the side-surface external electrodes 4 are formed on both side surfaces B of the multilayer body 2. The end-surface external electrodes 3 are connected to the end-surface-connection lead-out portions 15Ab of the end-surface-connection internal electrode layers 15A. Each end-surface external electrode 3 is formed such that it covers not only the end surface C but also a portion of each main surface A adjacent to the end surface C and a portion of each side surface B adjacent to the end surface C. The side surface external electrodes 4 are connected to the side-surface-connection lead-out portions 15Bb of the side-surface-connection internal electrode layers 15B. Each side-surface external electrode 4 is formed such that it covers not only a portion of the side surface B but also a portion of each main surface A adjacent to the side surface B.

### Firing Step S5

Subsequently, heating is performed at a set firing temperature for a predetermined period of time in a nitrogen atmosphere. As a result, the end-surface external electrodes 3 and the side-surface external electrodes 4 are fired onto the multilayer body 2, whereby the multilayer ceramic capacitor 1 illustrated in FIG. 1 is manufactured.

### Advantageous Effects of Multilayer Ceramic Capacitor 1 of the Present Example Embodiment

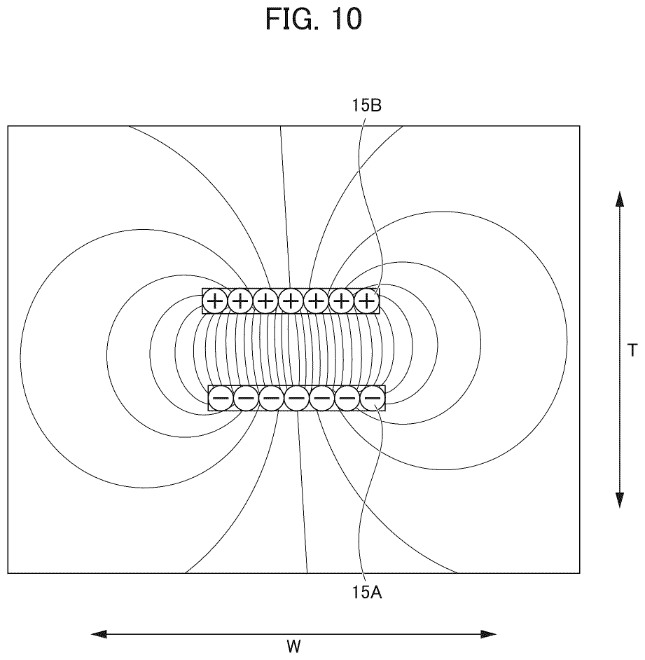

FIG. 10 is a diagram illustrating, as a common phenomenon, lines of electric force that are generated around internal electrode layers in a case where the number of internal electrode layers is two. The lines of electric force generated around the internal electrode layers curve at the edges of the internal electrode layers to draw circles, as illustrated. The curving of the lines of electric force causes polarization in the dielectric layers around the edges of the internal electrode layers, particularly in the region not sandwiched between the internal electrode layers. The polarization increases the capacitance of a multilayer ceramic capacitor. Thus, an increase of the lengths of the edges of the internal electrodes can increase the area of a region where polarization occurs, and thus, can further increase the capacitance of the multilayer ceramic capacitor.

In the multilayer ceramic capacitor 1 of the present example embodiment, the convex-concave portions 150 including the convexities 151 and the concavities 152 are provided on the edges 16 of the internal electrode layers 15. This configuration increases the lengths of the edges 16 of the internal electrode layers 15, without increasing the area of each internal electrode layer 15, thereby making it possible to increase the capacitance of the multilayer ceramic capacitor.

### Experimental Results

Multilayer ceramic capacitors of Examples 1 to 12 as the multilayer ceramic capacitors 1 of the present example embodiment, and the multilayer ceramic capacitors of Comparative Examples 1 to 3 were prepared. Each of the multilayer ceramic capacitors had a 1209 size (1.2 mm×0.9 mm).

Each of the multilayer ceramic capacitors of Examples had the convex-concave portions 150 on any of the edges 16AL of the end-surface-connection counter portion 15Aa of the end-surface-connection internal electrode layer 15A and extending in the length direction L; the edges 16BL of the side-surface-connection counter portion 15Ba of the side-surface-connection internal electrode layer 15B and extending in the length direction L; and the edges 16BW of the side-surface-connection counter portion 15Ba of the side-surface-connection internal electrode layer 15B and extending in the width direction W. In each of the multilayer ceramic capacitors of Examples, the concave-convex differences d were substantially equal and were set to 3 μm or 6 μm.

The multilayer ceramic capacitors of Comparative Example were not provided with the convex-concave portion 150.

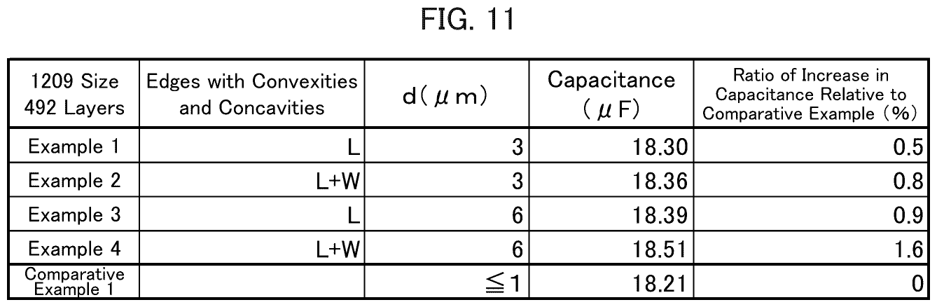

In a case where the relationship described as concave-convex difference d≤1 μm was satisfied, it was regarded that the convex-concave portion 150 was not provided. FIGS. 11, 12, and 13 show the results of measurement of the capacitances of the multilayer ceramic capacitors of Examples and Comparative Examples. FIGS. 11, 12, and 13 also show the ratio of an increase in the capacitance of each of Examples with respect to the capacitance of a Comparative Example.

Examples 1, 2, 3, and 4 and Comparative Example 1 shown in FIG. 11 each included a total of 492 laminated internal electrode layers 15.

Example 1 included the convex-concave portions 150 on the edges 16AL and the edges 16BL. The concave-convex difference d of Example 1 was 3 μm. Example 2 included the convex-concave portions 150 on the edges 16AL, the edges 16BL, and the edges 16BW. The concave-convex difference d of Example 2 was 3 μm. Example 3 included the convex-concave portions 150 on the edges 16AL and the edges 16BL. The concave-convex difference d of Example 3 was 6 μm. Example 4 included the convex-concave portions 150 on the edges 16AL, the edges 16BL, and the edges 16BW. The concave-convex difference d of Example 4 was 6 μm.

Comparative Example 1 did not include the convex-concave portion 150.

As shown in FIG. 11, a comparison between Comparative Example 1 and Examples 1, 2, 3, and 4 demonstrates that provision of the convex-concave portions 150 on the edges 16 increases the capacitor capacitance. With respect to Comparative Example 1, Example 1 exhibited a 0.5% increase in capacitor capacitance, Example 2 exhibited a 0.8% increase in capacitor capacitance, Example 3 exhibited a 0.9% increase in capacitor capacitance, and Example 4 exhibited a 1.6% increase in capacitor capacitance.

Furthermore, a comparison between Examples 1 and 2 and a comparison between Examples 3 and 4 demonstrate that the capacitor capacitance is further increased by increasing the number of edges provided with the convex-concave portions 150, that is, by providing the convex-concave portions 150 not only on the edges 16AL and the edges 16BL extending in the length direction L but also on the edges 16BW extending in the width direction W.

A comparison of Examples 1 and 2 with Examples 3 and 4 demonstrates that a concave-convex difference d of 6 μm results in a greater increase in capacitor capacitance than a concave-convex difference d of 3 μm.

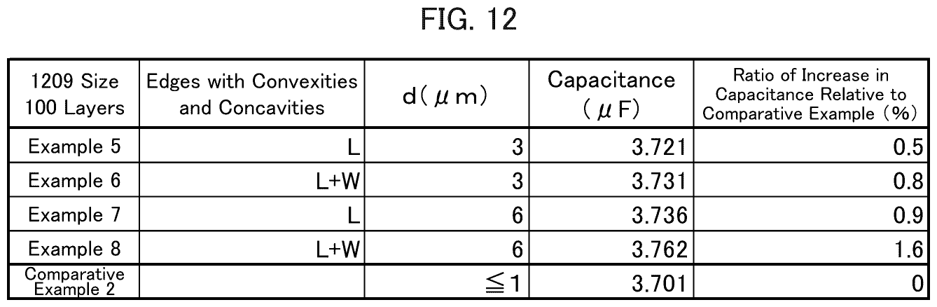

Examples 5, 6, 7, and 8 and Comparative Example 2 shown in FIG. 12 each included a total of 100 laminated internal electrode layers 15.

Example 5 included the convex-concave portions 150 on the edges 16AL and the edges 16BL. The concave-convex difference d of Example 5 was 3 μm. Example 6 included the convex-concave portions 150 on the edges 16AL, the edges 16BL, and the edges 16BW. The concave-convex difference d of Example 6 was 3 μm. Example 7 included the convex-concave portions 150 on the edges 16AL and the edges 16BL. The concave-convex difference d of Example 7 was 6 μm. Example 8 included the convex-concave portions 150 on the edges 16AL, the edges 16BL, and the edges 16BW. The concave-convex difference d of Example 8 was 6 μm. Comparative Example 2 did not include the convex-concave portion 150.

As shown in FIG. 12, a comparison between Comparative Example 2 and Examples 5, 6, 7, and 8 demonstrates that provision of the convex-concave portions 150 on the edges increases the capacitor capacitance. With respect to Comparative Example 2, Example 5 exhibited a 0.5% increase in capacitor capacitance, Example 6 exhibited a 0.8% increase in capacitor capacitance, Example 7 exhibited a 0.9% increase in capacitor capacitance, and Example 8 exhibited a 1.6% increase in capacitor capacitance.

Furthermore, a comparison between Examples 5 and 6 and a comparison between Examples 7 and 8 demonstrate that the capacitor capacitance is further increased by increasing the number of edges provided with the convex-concave portions 150, that is, by providing the convex-concave portions 150 not only on the edges 16AL and the edges 16BL extending in the length direction L but also on the edges 16BW extending in the width direction W.

A comparison of Examples 5 and 6 with Examples 7 and 8 demonstrates that a concave-convex difference d of 6 μm results in a greater increase in capacitor capacitance than a concave-convex difference d of 3 μm.

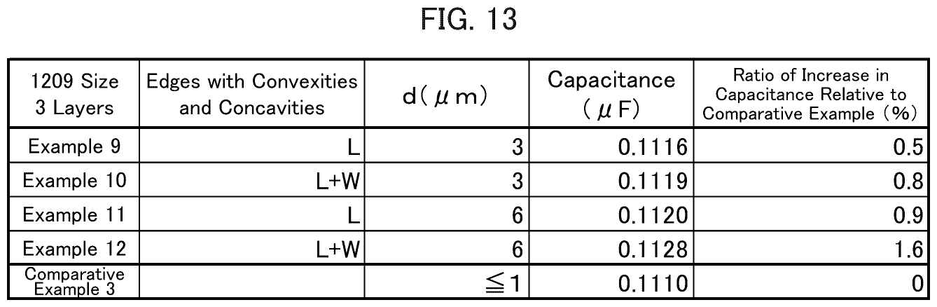

Examples 9, 10, 11, and 12 and Comparative Example 3 shown in FIG. 13 each included a total of 3 laminated internal electrode layers 15.

Example 9 included the convex-concave portions 150 on the edges 16AL and the edges 16BL. The concave-convex difference d of Example 9 was 3 μm. Example 10 included the convex-concave portions 150 on the edges 16AL, the edges 16BL, and the edges 16BW. The concave-convex difference d of Example 10 was 3 μm.

Example 11 included the convex-concave portions 150 on the edges 16AL and the edges 16BL. The concave-convex difference d of Example 11 was 6 μm. Example 12 included the convex-concave portions 150 on the edges 16AL, the edges 16BL, and the edges 16BW. The concave-convex difference d of Example 12 was 6 μm. Comparative Example 3 did not include the convex-concave portion 150.

As shown in FIG. 13, a comparison between Comparative Example 3 and Examples 9, 10, 11, and 12 demonstrates that provision of the convex-concave portions 150 on the edges increases the capacitor capacitance. With respect to Comparative Example 3, Example 9 exhibited a 0.5% increase in capacitor capacitance, Example 10 exhibited a 0.8% increase in capacitor capacitance, Example 11 exhibited a 0.9% increase in capacitor capacitance, and Example 12 exhibited a 1.6% increase in capacitor capacitance.

Furthermore, a comparison between Examples 9 and 10 and a comparison between Examples 11 and 12 demonstrate that the capacitor capacitance is further increased by increasing the number of edges provided with the convex-concave portions 150, that is, by providing the convex-concave portions 150 not only on the edges 16AL and the edges 16BL extending in the length direction L but also on the edges 16BW extending in the width direction W.

A comparison of Examples 9 and 10 with Examples 11 and 12 demonstrates that a concave-convex difference d of 6 μm results in a greater increase in capacitor capacitance than a concave-convex difference d of 3 μm.

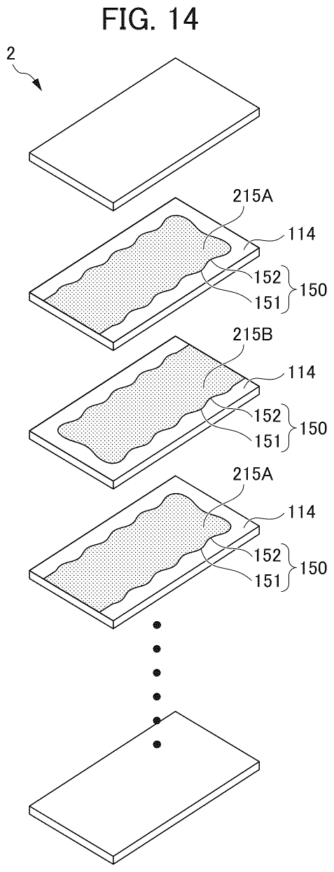

While example embodiments of the present invention have been described above, it should be noted that various modifications can be made within the scope of the present invention. For example, the multilayer ceramic capacitors 1 of the above-described example embodiments include the end-surface-connection internal electrode layers 15A and the side-surface-connection internal electrode layers 15B that are alternately arranged. However, this is a non-limiting example. FIG. 14 is an exploded perspective view of a multilayer body 2 of a multilayer ceramic capacitor according to a modification of an example embodiment of the present invention. As illustrated, the multilayer ceramic capacitor of the modification include no side-surface-connection internal electrode layer, and accordingly, no side-surface external electrode.

As illustrated in FIG. 14, in the multilayer ceramic capacitor according to the modification, first internal electrode layers 215A connected to one end-surface external electrode (not shown) and second internal electrode layers 215B connected to the other end-surface external electrode (not shown) are alternately arranged. Convex-concave portions 150 are provided on edges of the first internal electrode layer 215A and edges of the second internal electrode layer 215B.

In this multilayer ceramic capacitor according to the modification, the convex-concave portions 150 including convexities 151 and concavities 152 are provided on the edges of the internal electrode layers 215A and 215B, likewise to the above-described example embodiments. This configuration makes it possible to increase the length of the edges of the internal electrode layers 215A and 215B without increasing the area of each of the internal electrode layers 215A and 215B, whereby the capacitance of the multilayer ceramic capacitor can be increased.

Furthermore, in the example embodiments and the modifications descried above, the convex-concave portions provided on the edges of the internal electrode layers have the shape of sine waves, but this is a non-limiting example. In another modification, the convex-concave portion may have a shape of rectangular waves, a shape of sawtooth waves, or a shape of triangular waves.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A multilayer ceramic capacitor comprising:
a multilayer body including internal electrode layers and dielectric layers that are alternately laminated; and
external electrodes on at least a pair of opposite outer surfaces from among outer surfaces of the multilayer body and extending in a lamination direction;
each internal electrode layer including a counter portion and a lead-out portion that extends from the counter portion to the external electrode, the counter portion of one of a pair of the internal electrode layers adjacent to each other in the lamination direction overlaps with the counter portion of each of a remainder of the internal electrode layers;
the counter portion including on edges thereof, a convex-concave portion that includes a convexity and a concavity alternating with each other, the convexity bending toward the outer surface adjacent to the edge, the concavity bending away from the outer surface adjacent to the edge.

2. The multilayer ceramic capacitor according to claim 1, wherein
the outer surfaces include end surfaces situated at both ends of the multilayer body in a length direction that intersects with the lamination direction;
the external electrodes include end-surface external electrodes on the end surfaces, respectively; and
the internal electrode layers include an end-surface-connection internal electrode layer including an end-surface-connection lead-out portion as the lead-out portion, the end-surface-connection lead-out portion extending to the end-surface external electrode.

3. The multilayer ceramic capacitor according to claim 1, wherein
the outer surfaces include side surfaces at both ends of the multilayer body in a width direction that intersects with the lamination direction;
the external electrodes include side-surface external electrodes on the side surfaces, respectively; and
the internal electrode layers include a side-surface-connection internal electrode layer including a side-surface-connection lead-out portion as the lead-out portion, the side-surface-connection lead-out portion extending to the side-surface external electrode.

4. The multilayer ceramic capacitor according to claim 1, wherein
the edges include an edge extending in a length direction that intersects with the lamination direction, and the convex-concave portion on the edge extending in the length direction includes two or more consecutive sets of the convexity and the concavity.

5. The multilayer ceramic capacitor according to claim 1, wherein the convex-concave portion on at least one of the edges includes a location at which, for the convexity and the concavity adjacent to each other, a difference between a distance from an outermost point of the convexity to the outer surface and a distance from an innermost point of the concavity to the outer surface is about 3 μm or more.

6. The multilayer ceramic capacitor according to claim 1, wherein when the internal electrode layers included in the multilayer body are viewed from one of main surfaces on both sides of the multilayer body in the lamination direction, a positional deviation between an outermost point of the convexity of one of the internal electrode layers and an outermost point of the convexity of another of the internal electrode layers is about 250 μm or less in a length direction intersecting with the lamination direction.

7. The multilayer ceramic capacitor according to claim 1, wherein
in a cross section that extends in the lamination direction and a length direction intersecting with the lamination direction and that is spaced farther apart than an outermost point of the convexity and less farther apart than an innermost point of the concavity from one of side surfaces on both sides of the multilayer body in a width direction intersecting with the lamination direction;
regions where the internal electrode layers are exposed and are arranged one above the other in the lamination direction alternate with regions where the internal electrode layers are not exposed and are arranged one above the other in the lamination direction.

8. The multilayer ceramic capacitor according to claim 1, wherein each of the edges includes five convexities and four concavities between adjacent ones of the convexities.

9. The multilayer ceramic capacitor according to claim 1, wherein the convex-concave portion includes two or more consecutive sets of one of the convexities and one of the concavities.

10. The multilayer ceramic capacitor according to claim 1, wherein the convex-concave portion includes four consecutive sets of one of the convexities and one of the concavities.

11. The multilayer ceramic capacitor according to claim 1, wherein the convex-concave portion on all of the edges includes a location at which, for the convexity and the concavity adjacent to each other, a difference between a distance from an outermost point of the convexity to the outer surface and a distance from an innermost point of the concavity to the outer surface is about 3 μm or more.

12. The multilayer ceramic capacitor according to claim 1, wherein each of the external electrodes includes a base electrode layer and a plated layer.

13. The multilayer ceramic capacitor according to claim 12, wherein the plated layer includes a nickel plated layer and a tin plated layer.

14. The multilayer ceramic capacitor according to claim 1, wherein the convex-concave portion has a sine wave shape.

15. The multilayer ceramic capacitor according to claim 1, wherein the convex-concave portion has a rectangular wave shape.

16. The multilayer ceramic capacitor according to claim 1, wherein the convex-concave portion has a sawtooth wave shape.

17. The multilayer ceramic capacitor according to claim 1, wherein the convex-concave portion has a triangular wave shape.
